(19) United States
(12) Patent Application Publication
(10) Pub. No.: US 2022/0145681 A1
(43) Pub. Date: May 12, 2022

(54) Hinge Cover Assembly

(71) Applicant: Michael Hageman, Kyle, TX (US)

(72) Inventor: Michael Hageman, Kyle, TX (US)

(21) Appl. No.: 17/521,670

(22) Filed: Nov. 8, 2021

Related U.S. Application Data
(60) Provisional application No. 63/110,785, filed on Nov. 6, 2020.

(51) Int. Cl. E05D 11/00; E05D 11/06

(52) U.S. Cl. CPC E05D 11/0054; E05D 11/06

(57) ABSTRACT

This hinge cover assembly provides a cover member, stopping member, and fastener mechanism that work in tandem to stop the relative rotation of objects along an axis. This improved hinge cover assembly can be incorporated into multiple hinged object assemblies, including doors, windows, and cabinets.

### CROSS-REFERENCE TO RELATED APPLICATIONS

This application claims the benefit of U.S. Provisional Patent Application No. 63/110,785, filed Nov. 6, 2020, which is incorporated herein by reference in its entirety.

### FIELD

In general, the present disclosure describes hinge cover assemblies. Specifically, a hinge cover assembly for limiting the angle of rotation of hinged objects about an axis at a predetermined angle.

### BACKGROUND

Hinged objects that rotate relative to an axis typically only have a limited angle of rotation. However, in many practical uses for hinges and hinged objects, a smaller angle of rotation between the objects may be desired. When a hinged object, such as a door, cabinet, or window, swings open too far, it can damage surrounding surfaces on walls, cabinets, mirrors, chairs, tables, appliances, and any other movable or non-moveable fixtures that may be in its path. A hinged object that opens too far can also be dangerous to the safety and flow of a home or building.

This is why in certain applications a hinge stop is essential to prevent damage to walls or other surfaces when a door is opened, or simply to meet a specific safety or construction constraint presented. To achieve a smaller angle of rotation, a door or hinge stop may be installed. A door or hinge stop allows the user to set a predetermined angle about which the hinged objects may move by stopping at least one of the hinged objects at a set point from moving in a certain direction.

However, incorporating a door or hinge stop into a practical application has historically necessitated the use of unattractive and undesirable hardware that must be added into a home or building design, such as spring stops, door closers, floor mounts, wall mounts, hinge pin door stops, or overhead door stops. Many of these external stops have their own issues and may not meet the needs of every project, especially specialty construction projects. Further, external door or hinge stops can actually lead to damage to the hinged objects themselves over time. For example, a hinge pin doorstop will likely damage both the door and the door frame due to the small surface area of the point of connection with the door and door frame. Traditional hinge or doorstops may also have insufficient stopping power to meet the needs of a user.

Therefore, a need exists for a hinge stop that prevents damage to walls or other surfaces surrounding hinged objects that allows users to meet specific safety or construction constraints, but also meshes with the design of a specialty construction project and prevents damage to the hinged objects themselves.

### SUMMARY

This summary is provided to introduce a selection of concepts that are further described below in the detailed description. However, many modifications are possible without materially departing from the teachings of this disclosure. Accordingly, such modification are intended to be included within the scope of this disclosure as defined in the claims. This summary is not intended to identify key or essential features of the claimed subject matter, nor is it intended to be used as an aid in limiting the scope of the claimed subject matter.

Devices and methods to stop the relative rotation of two objects about a hinge are described herein. Embodiments may include a hinge cover assembly with a cover member capable of covering a hinge, the hinge being capable of connecting a plurality of objects that rotate relative to each other along an axis, at least one stopping member attached to the cover member and adapted to prevent relative rotation of the plurality of objects at a predetermined angle, and a fastener mechanism capable of securing the cover assembly over the hinge.

One or more embodiments may include the device of the preceding paragraph, wherein the fastener mechanism secures to the at least one object and comprises at least one pre-drilled hole and at least one screw.

One or more embodiments may include the device of any preceding paragraph, wherein the fastener mechanism comprises at least one eye bolt and a hinge pin, the hinge pin capable of being fed through the at least one eye bolt and a barrel of the hinge.

One or more embodiments may include the device of any preceding paragraph, further comprising a cushion member on the at least one stopping member.

Certain further embodiments may include a hinge cover assembly with a single manufactured unit, the single manufactured unit comprising a cover member adapted to partially enclose a door hinge and at least one stopping member adapted to stop the relative rotation of an object about an axis at a predetermined angle, and a fastener mechanism capable of securing the cover assembly around the hinge, wherein the cover assembly and hinge are movably connected.

One or more embodiments may include the device of any preceding paragraph, wherein the fastener mechanism is a part of the single manufactured unit and comprises at least one pre-drilled hole.

One or more embodiments may include the device of any preceding paragraph, wherein the fastener mechanism secures the cover assembly to at least one object with at least one mechanical fastener.

One or more embodiments may include the device of any preceding paragraph, wherein the fastener mechanism comprises at least one eye bolt and a hinge pin, the hinge pin capable of being fed through the at least one eye bolt and the hinge.

One or more embodiments may include the device of any preceding paragraph, further comprising a cushion member on the at least one stopping member.

### BRIEF DESCRIPTION OF DRAWINGS

Certain embodiments of the disclosure will hereafter be described with reference to the accompanying drawings, wherein like reference numerals denote like elements. It is emphasized that, in accordance with standard practices in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 illustrates a perspective view of an embodiment of the present disclosure with a fastener mechanism that connects to an object.

FIG. 2 illustrates a front view of an embodiment of the present disclosure with a fastener mechanism to that connects to an object.

FIG. 3 illustrates a top view of an embodiment of the present disclosure attached to a door frame with a door stopped at a first exemplary predetermined angle.

FIG. 4 illustrates a top view of an embodiment of the present disclosure attached to a door frame with a door stopped at a second exemplary predetermined angle.

FIG. 5 illustrates a perspective view of an embodiment of the present disclosure with a pin attachment fastener mechanism.

FIG. 6 illustrates a front view of an embodiment of the present disclosure with a pin attachment fastener mechanism.

FIG. 7 illustrates a side view of an embodiment of the present disclosure with a pin attachment fastener mechanism and an engaged replacement pin.

FIG. 8 illustrates a top view of an embodiment of the present disclosure with a pin attachment fastener mechanism with a door stopped at a first exemplary predetermined angle.

FIG. 9 illustrates a top view of an embodiment of the present disclosure with a pin attachment fastener mechanism with a door stopped at a second exemplary predetermined angle.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

The term “hinge” should be understood by those of ordinary skill in the art to include a mechanical bearing that connects at least two solid objects, with one or both of the objects being able to rotate relative to the other object about a fixed axis.

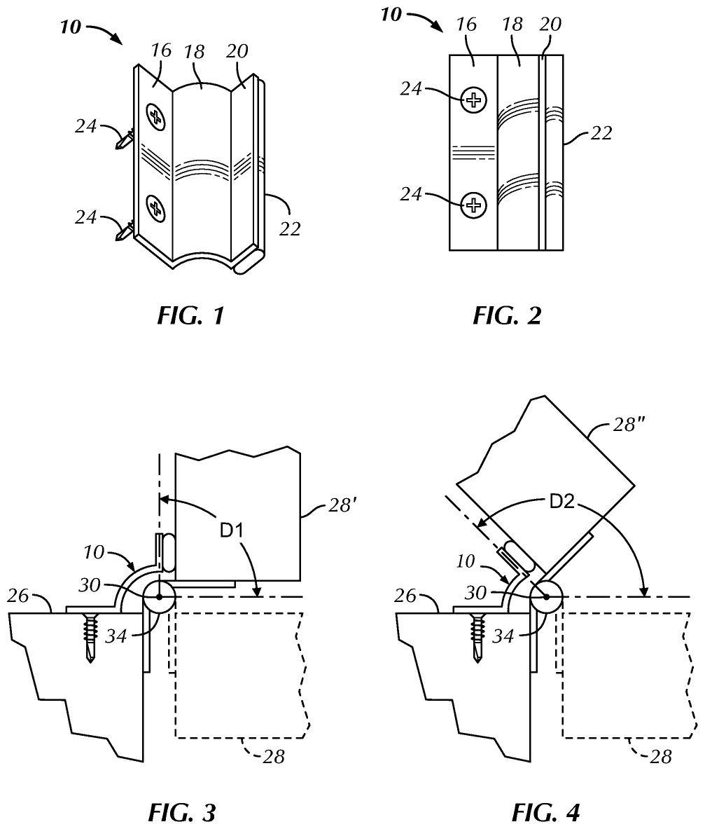

FIG. 1 illustrates a perspective view of an embodiment of the present disclosure with a fastener mechanism (16, 24) that connects to an object. The cover member 18 is attached to a fastener plate 16 and a stopping member 20. The stopping member 20 has a cushion member 22 to further protect an object, such as a door, window, or cabinet, from damage when it abuts the stopping member 20. In this embodiment, cover member 18 is curved to cover a barrel hinge. However, the present disclosure is not limited to barrel hinge applications and may be used on other types of hinges including, but not limited to, butt hinges, piano hinges, butterfly hinges, flush hinges, pivot hinges, and spring hinges.

The cover member 18, fastener plate 16, and stopping member 20 are typically made of the same material. However, in certain applications the cover member 18, fastener plate 16, and stopping member 20 may be of different materials to meet the needs of a particular application. The present disclosure may be made of steel, angle iron, square tubing, flat bar, c-channel, aluminum, titanium, cold rolled steel, brass, nickel, monel, other metal or metal alloys, hard cast plastic, resin, Acrylonitrile Butadiene Styrene (ABS), Polylactic Acid (PLA), High Impact Polystyrene (HIPS), Polyethylene Terephthalate (PETG), Nylon, Carbon Fiber filaments, Acrylic Styrene Acrylonitrile (ASA), Polycarbonate, Polypropylene, metal filled filaments, wood filaments, Polyvinyl Alcohol, or other similar material.

The fastener mechanism (16, 24) is made up of a fastener plate 16 with two pre-drilled holes and screws 24 meant to drill directly into an object. While screws are shown in the present disclosure, any mechanical fastener may be used to secure the fastener mechanism (16, 24) to the object. In certain other embodiments, the fastener mechanism may be a welded piece or portion of the cover assembly, with the hinge cover assembly being welded directly with a door frame to install and secure the cover assembly.

The cushion member 22 further protects an object from damage when it abuts the stopping member 20 of the cover assembly 10. The cushion member 22 may be made of a rubber weather stripping. However, any material that protects an object from damage when it abuts the stopping member may be used, including but not limited to rubber, foam, fabric, Styrofoam, paper, and polysheeting.

FIG. 2 illustrates a front view of an embodiment of the present disclosure with a fastener mechanism (16, 24) that attaches directly to an object. The screws 24 are set within the fastener plate 16, with the cover member 18 shown between the fastener plate 16 and stopping member 20 with an attached cushion member 22. The cover member 18, stopping member 20, and fastener plate 16 are welded into one piece to increase the stopping power of the cover assembly 10. In certain embodiments, the present disclosure can be manufactured using aluminum extrusion. In certain other embodiments, the present disclosure can be manufactured by injection molding, additive manufacturing, including but not limited to 3D printing, or dye extrusion.

In applications with a door and door frame, the force of the door when it meets the stopping member 20 can be powerful. The large surface area of the stopping member 20 combined with the cushion member 22 adds to the stopping power of the cover assembly 10 and prevents damage to the door because the opposing force of the cover assembly 10 is spread out along the large surface area of the stopping member 20, thus lessening the likelihood of damaging the door. This contrasts with more traditional door stops that concentrate the opposing force on a smaller surface area and thus apply too much pressure to one area of the door causing damage.

In certain embodiments, it may be desired to have more than one hinge cover assembly acting on the same object. Having multiple hinge cover assemblies on the same door may be desired to increase the stopping power and opposing force pushing back against the door. Multiple hinge cover assemblies could further spread out the relative forces pushing back against the door, thus reducing the likelihood of damage due to a high concentration of force at a single point.

FIG. 3 illustrates a top view of an embodiment of the present disclosure attached to a door frame 26 with a door 28 stopped at an exemplary first predetermined angle D1. The predetermined angle D1 is outlined by the relative position of the fastener plate 16 and the stopping member 20.

The door 28 and door frame 26 are connected by a hinge 30. The door 28 is able to rotate along a hinge pivot 30 closer to the door frame 26, shown by the second position of the door 28′. When the door 28 is closed, the leaves of the hinge 34 are parallel. When a user opens the door 28′, the door 28′ will open to the first predetermined angle D1 but may not move beyond the angle D1 because it meets the stopping member 20 and cushion member 22 of the cover assembly 10.

FIG. 4 illustrates a top view of an embodiment of the present disclosure attached to a door frame 26 with a door 28″ stopped at second exemplary predetermined angle D2. The predetermined angles (D1, D2) may be set by the manufacturer or user depending on the needs of a particular application. The predetermined angle (D1, D2) is measured from the door frame to the stopping member 20 of the cover assembly 10.

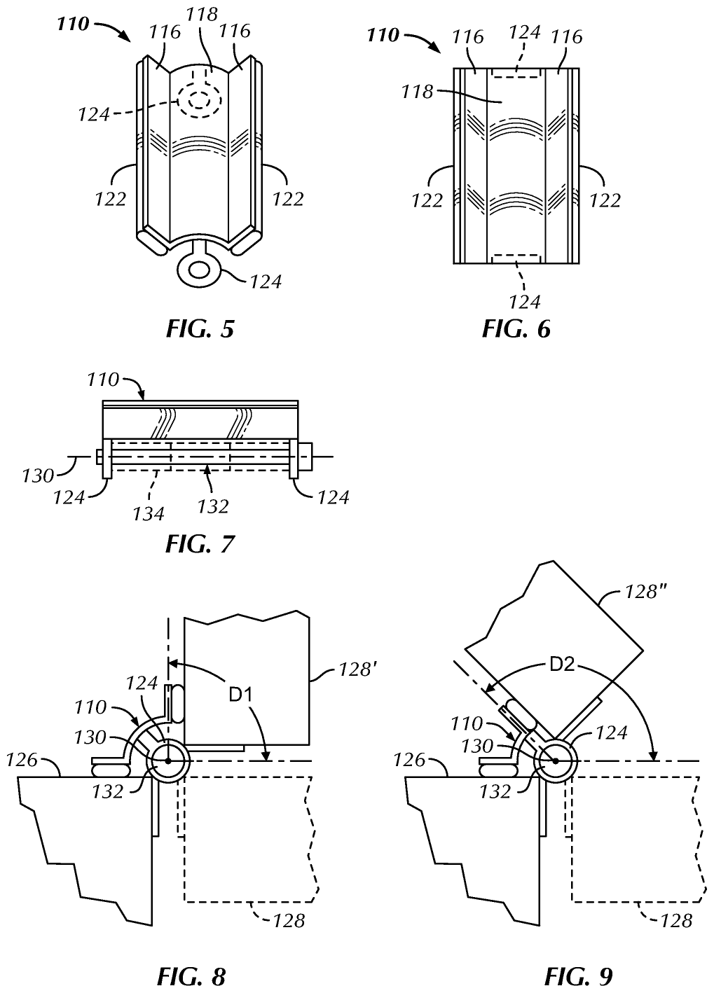

FIG. 5 illustrates a perspective view of an embodiment of the present disclosure with a pin attachment fastener mechanism 124. The pin attachment fastener mechanism 124 protrudes from the cover member 118. A replacement hinge pin (not presently shown) can then be fed through the pin attachment fastener mechanism 124 and the barrel of a hinge (not presently shown) to secure the cover assembly 110 to hinge assembly. The pin attachment fastener mechanism 124 can be a set of eye bolts. However, it should be readily apparent that any fastener may be used that allows for a replacement pin (not presently shown) to be fed through the barrel of a hinge (not presently shown). Further, although two fastener mechanisms 124 are shown, a single fastener mechanism may also be used without departing from the spirit of the present disclosure.

FIG. 5 also shows two stopping members 116 and two cushion members 122. Because of the pin attachment fastener mechanism 124 being attached to the hinge rather than a door frame, the cover assembly 110 may pivot about the hinge pivot as well. The addition of two stopping members 116 allows a user to install the cover assembly 110 without damaging either object in the hinge assembly, while still maintaining the same stopping power. The additional cushion member 122 protects both objects from damage when the cover assembly 110 is engaged.

In certain other embodiments, the present disclosure may be installed by welding directly at least part of the hinge cover assembly to the door frame. The fastener mechanism is such embodiment is then the portion or portions of the cover assembly welded to the door frame.

FIG. 6 illustrates a front view of an embodiment of the present disclosure with a pin attachment fastener mechanism 124. This view further demonstrates the relative positions of the cover member 118, the stopping members 116, the cushion members 122, and the pin attachment fastener mechanisms.

FIG. 7 illustrates a side view of an embodiment of the present disclosure with a pin attachment fastener mechanism 124 and an engaged replacement pin 132. The engaged replacement pin 132 is fed through a pin attachment fastener mechanism 124, then fed through the barrel of the hinge 134, and then passes through a second pin attachment fastener mechanism 124. The cover assembly 110 can then pivot about the hinge pivot 130.

FIG. 8 illustrates a top view of an embodiment of the present disclosure with a pin attachment fastener mechanism 124 with a door 128 stopped at an exemplary predetermined angle D1. The door 128 and door frame 126 are connected by a hinge 132. The door 128 is able to rotate along a hinge pivot 130 closer to the door frame 126, shown by the second position of the door 128′. When the door 128 is closed, the leaves of the hinge 132 are parallel. When a user opens the door 128′, the door 128′ will open to the first predetermined angle D1 because the stopping members 116 and cushion members 122 abut both the door 128′ and door frame 126 to stop the motion of the door 128′ and prevent it from opening further than the predetermined angle D1.

FIG. 9 illustrates a top view of an embodiment of the present disclosure with a pin attachment fastener mechanism 124 with a door 128′ stopped a second exemplary predetermined angle D2. Because of the way the cover assembly 110 pivots about the hinge 132, at any point in time the stopping members 122 may be touching just the door frame 126, just the door 128, both the door 128 and the door frame 126, or neither the door 128 nor door frame 126.

While various devices and methods have been described above in connection with several illustrative embodiments, it is to be understood that other similar embodiments may be used or modified and additions may be made to the described embodiments for performing the same function disclosed herein without deviating therefrom. For example, although a door is used as an exemplary model at several points in this disclosure, the present disclosure may also be implemented on other hinged applications such as a window or cabinet.

Further, all embodiments disclosed are not necessarily in the alternative, as various embodiments may be combined or subtracted to provide the desired characteristics. Variations can be made by one having ordinary skill in the art without departing from the spirit and scope hereof. The scope of the present disclosure is determined by the claims that follow.

What is claimed is:

1. A hinge cover assembly, comprising:
a cover member capable of covering a hinge, the hinge being capable of connecting a plurality of objects that rotate relative to each other along an axis;
at least one stopping member attached to the cover member and adapted to prevent relative rotation of the plurality of objects at a predetermined angle; and
a fastener mechanism capable of securing the cover assembly over the hinge.

2. The hinge cover assembly of claim 1, wherein the fastener mechanism secures to at least one object and comprises at least one pre-drilled hole and at least one screw.

3. The hinge cover assembly of claim 1, wherein the fastener mechanism comprises at least one eye bolt and a hinge pin, the hinge pin capable of being fed through the at least one eye bolt and a barrel of the hinge.

4. The hinge cover assembly of claim 1, further comprising a cushion member on the at least one stopping member.

5. A hinge cover assembly, comprising:
A single manufactured unit, the single manufactured unit comprising a cover member adapted to partially enclose a door hinge and at least one stopping member adapted to stop the relative rotation of an object about an axis at a predetermined angle; and
a fastener mechanism capable of securing the cover assembly around the hinge, wherein the cover assembly and hinge are movably connected.

6. The hinge cover assembly of claim 5, wherein the fastener mechanism is a part of the single manufactured unit and comprises at least one pre-drilled hole.

7. The hinge cover assembly of claim 6, wherein the fastener mechanism secures the cover assembly to at least one object with at least one mechanical fastener.

8. The hinge cover assembly of claim 5, wherein the fastener mechanism comprises at least one eye bolt and a hinge pin, the hinge pin capable of being fed through the at least one eye bolt and the hinge.

9. The hinge cover assembly of claim 5, further comprising a cushion member on the at least one stopping member.
